(19) United States
(12) Patent Application Publication
(10) Pub. No.: US 2026/0276068 A1
(43) Pub. Date: Sep. 17, 2026

(54) DIFFERENTIAL WITH DIFFERENTIAL GEARS AND A DRIVE GEAR

(71) Applicant: Schaeffler Technologies AG & Co. KG, Herzogenaurach (DE)

(72) Inventors: Jochen Loeffelmann, Eggolsheim (DE); Peter Welker, Herzogenaurach (DE)

(73) Assignee: Schaeffler Technologies AG & Co. KG, Herzogenaurach (DE)

(21) Appl. No.: 19/140,357

(22) PCT Filed: Dec. 18, 2023
(86) PCT No.: PCT/DE2023/100977

§ 371 Date: Jun. 18, 2025

(30) Foreign Application Priority Data
Dec. 19, 2022 (DE) 10 2022 133 888.6

(51) Int. Cl. F16H 48/08; F16H 48/38

(52) U.S. Cl. CPC F16H 48/08; F16H 2048/085; F16H 2048/385; F16H 2048/387

(57) ABSTRACT

A differential includes a drive gear, a journal, and a pair of differential gears mounted rotatably in the drive gear on the journal. The drive gear includes a radially outer toothing, a pair of a radially extending grooves, and a pair of radial recesses, each surrounding one of the pair of radially extending grooves. The journal has distal ends, each mounted in one of the pair of radially extending grooves. Each of the differential gears has an axially outwardly directed end face arranged as a planar guide surface and engaged one of the pair of radial recesses.

### CROSS-REFERENCE TO RELATED APPLICATIONS

This application is the United States National Phase of PCT Appln. No. PCT/DE2023/100977 filed Dec. 18, 2023, which claims priority to German Application No. DE102022133888.6 filed Dec. 19, 2022, the entire disclosures of which are incorporated by reference herein.

### TECHNICAL FIELD

The present disclosure relates to a differential with differential gears and a drive gear, wherein the drive gear comprises a toothing system which runs outside on the orbiting side about a rotational axis, and the differential gears are mounted rotatably in the drive gear, wherein the differential gears rotate jointly on one journal.

### BACKGROUND

DE 10 2018 124 491 A1 discloses a differential with differential gears, a drive gear and at least one cover. The drive gear has a toothing system which runs on the orbiting side about a rotational axis and is provided with bearing points on the inside. The lugs of a journal on which the differential gears are mounted engage in the bearing points. As a result, the differential gears are mounted rotatably in the drive gear.

DE 10 2020 113 361 A1 shows a housing for accommodating the transmission of a bevel gear differential. The housing comprises a first housing part made of sheet metal and a second housing part made of sheet metal. At least one lug protrudes from the first housing part and is formed in one piece with the first housing part and extends through a corresponding opening formed in the second housing part. In this case, a free end of the lug protruding beyond the second housing part is plastically deformed in such a way that the first housing part is firmly connected to the second housing part.

DE 10 2009 055 867 A1 shows a differential having at least one drive gear, at least two axle wheels, at least one differential gear and at least one connecting element, wherein the connecting element experiences at least a first torque at least from the drive gear, and the connecting element transmits at least a second torque to at least one of the at least two axle wheels. The drive gear is designed in such a way that the drive gear at least partially encloses at least one interior space, and that the connecting element is arranged at least partially within the interior space at least partially enclosed by the drive gear.

DE 10 2015 220 518 A1 shows a differential gearing that distributes the torque of a drive element that can rotate together with pinion carrier parts onto a pair of output shafts, in particular about such a differential gearing that is provided with a pair of side gears, which have a toothing system on their outer circumference, in which pinions engage, and which are each connected to one of the output shafts, and with cover parts that cover at least one of the side gears on the outside and rotate as a unit with the drive element. Even under harsh operating conditions when the pinions rotate at high speed, etc., the sliding parts of the pinions and the parts of the pinions in which the side gears engage are sufficiently supplied with lubricating oil and seizure of the sliding and intermeshing parts is effectively prevented. At least one of the cover parts is provided with oil retaining parts that cover the back of the side gear in first specific regions, which include regions that overlap with the pinions when viewed from the outside in the axial direction of the output shafts, and is provided with cut-outs that expose the back of the side gear in second specific regions that do not overlap with the pinions.

### SUMMARY

The differential explained at the outset has differential gears and a drive gear, wherein the drive gear comprises a toothing system which runs outside on the orbiting side about a rotational axis, and the differential gears are mounted rotatably in the drive gear, wherein the differential gears rotate jointly on one journal. In this differential, a guide element which is configured as a planar guide surface is arranged in the axial direction of extent of the journal between the differential gear and the drive gear. To form such a differential, only one tool is required to form the components adjacent to the guide surface, in particular the drive gear. This reduces production and assembly costs.

According to the present disclosure, the axially outwardly directed end face of the differential gear is configured as a planar guide surface. This allows the elimination of separate guide elements, which further reduces production costs.

According to the disclosure, the journal is mounted in a radially extending groove of a main body of the drive gear, and the planar guide surface engages in a recess of the main body surrounding the groove. The recess can be formed jointly with the groove using the one tool on the main body of the drive gear. This can be done by milling and grinding or by broaching. In the case of possible hard machining, there is no interrupted cut.

According to a further embodiment, a separate disc is arranged as a planar guide surface between the differential gear and the drive gear. This separate disc allows precise adjustment of the differential gear to the drive gear.

According to a further embodiment, the separate disc has a coating. Such a coating improves the emergency running properties of the differential.

According to a further embodiment, the differential gears are in engagement with the drive gear and are mounted so as to be rotatable about their own axis. This ensures that the differential gears have a rotational axis that is perpendicular to the rotational axis of the drive gear and enables the differential gears to access the driven gears in a small installation space.

According to a further embodiment, the journal extending axially and protruding beyond the planar guide surface of the differential gears is mounted in the groove such that the journal is mounted in the circumferential direction about the rotational axis of the differential gears. This increases the accuracy of the assembly, which has a particularly positive effect on the precision of the tooth contact between the differential gears and the driven gears.

### BRIEF DESCRIPTION OF THE DRAWINGS

The disclosure allows for numerous embodiments. One of them is explained in more detail using the figures shown in the drawings.

In the drawings:

FIG. 1 shows an exemplary embodiment of the differential according to the present disclosure;

FIG. 2 shows an exemplary embodiment of a drive gear; and

FIG. 3 shows an exemplary embodiment of a differential gear/driven gear unit.

### DETAILED DESCRIPTION

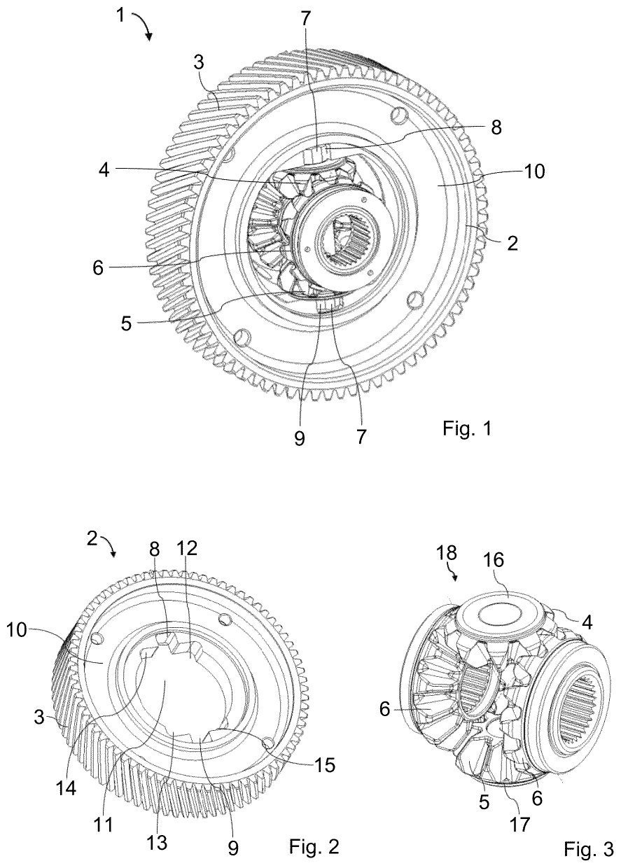

In FIG. 1, an exemplary embodiment of the differential according to the present disclosure is shown in an overall view. The differential 1 includes a drive gear 2 with a toothing system 3 configured as a spur helical toothing system and two differential gears 4, 5 which engage in two driven gears 6 arranged between them. Only one of the driven gears 6 is shown. The differential gears 4, 5 and the driven gears 6 are configured as bevel gears. Differential speeds on the vehicle wheels are compensated for via the differential gears 4, 5 in conjunction with the driven gears 6, for which purpose said wheels mesh with the driven gears 6 and are mounted on the drive gear 2 so as to be rotatable about their own rotational axis. The differential gears 4, 5 are each mounted in a groove 8, 9 of the drive gear 2 via a journal 7 extending radially in the drive gear 2. The grooves 8, 9 form bearing points for the journal 7, which sits rotatably in the groove 8, 9.

FIG. 2 shows an exemplary embodiment of the drive gear 2 as used in FIG. 1. The drive gear 2 is a sum shaft of the differential, via which power from a vehicle drive is introduced into the differential and from there is distributed to the vehicle wheels. The drive gear 2 has a main body 10 which has a central opening 11 for receiving the differential gear/driven gear unit 18, which is shown in FIG. 3. Inside the opening 11 of the drive gear 2, two radial grooves 8, 9 are formed opposite each other. Each groove 8, 9 is surrounded by a recess 12, 13, whereby the groove 8, 9 projects beyond the recess 12, 13. The groove 8, 9 and the recess 12, 13 can be easily created with a tool by broaching or milling and grinding.

The base 14, 15 of the recesses 12, 13 represents a first planar surface on which the end faces 16, 17 of the differential gears 4, 5 rest. The axially outwardly directed end faces 16, 17 of the differential gears 4, 5 are also planar and form a further planar guide surface, which ensures a high accuracy of fit with the recess 12, 13. The dimensions of the recesses 12, 13 are adapted to the size of the end faces 16, 17.

In an alternative embodiment, the flat end face 16, 17 of the differential gears 4, 5 is replaced by a flat disc, which engages in a recess 12, 13 and thus forms the flat guide surface.

### Reference Numerals

1 Differential
2 Drive gear
3 Toothing system of the drive gear
4 Differential gear
5 Differential gear
6 Driven gear
7 Journal
8 Groove
9 Groove
10 Main body of the drive gear
11 Opening of the drive gear
12 Recess
13 Recess
14 Base of the recess
15 Base of the recess
16 End face of the differential gear
17 End face of the differential gear
18 Differential gear/driven gear unit

1. A differential having differential gears and a drive gear, wherein the drive gear has a toothing system which runs outside on the orbiting side about a rotational axis and the differential gears are mounted rotatably in the drive gear, wherein the differential gears rotate jointly on one journal, wherein a guide element which is configured as a planar guide surface is arranged in the axial direction of extent of the journal between the differential gear and the drive gear, wherein an axially outwardly directed end face of the differential gear is configured as a planar guide surface, and the journal is mounted in each case in a radially extending groove of a main body of the drive gear, and the planar guide surface engages in a radial recess, which surrounds the groove, of the main body and the recess jointly with the groove is formable by a single tool on the main body of the drive gear.

2. The differential according to claim 1, wherein a separate disc is arranged as a planar guide surface between the differential gear and the drive gear.

3. The differential according to claim 2, wherein the separate disc has a coating.

4. The differential according to claim 1, wherein the differential gears are in engagement with the drive gear and are mounted so as to be rotatable about their own rotational axis.

5. The differential according to claim 1, wherein the journal extending radially to the drive gear and protruding beyond the planar guide surface of the differential gears is mounted in the groove such that the journal is mounted in the circumferential direction about the rotational axis of the differential gears.

6. A differential comprising:
a drive gear, comprising:
a radially outer toothing;
a pair of a radially extending grooves; and
a pair of radial recesses, each surrounding one of the pair of radially extending grooves;
a journal comprising distal ends, each mounted in one of the pair of radially extending grooves;
a pair of differential gears, mounted rotatably in the drive gear on the journal, each of the differential gears comprising an axially outwardly directed end face arranged as a planar guide surface and engaged one of the pair of radial recesses.

7. The differential of claim 6, further comprising a pair of discs, each arranged between one of the axially outwardly directed end faces and one of the pair of radial recesses.

8. The differential of claim 6, wherein each of the pair of discs comprises a coating.

9. The differential of claim 6, wherein each of the pair of differential gears is rotatable about its own rotational axis.

10. The differential of claim 6, wherein the distal ends of the journal extend through the planar guides into the radially extending grooves such that the journal is mounted about a rotational axis of the pair of differential gears.
